(19) United States
(12) Patent Application Publication
(10) Pub. No.: US 2016/0374876 A1
(43) Pub. Date: Dec. 29, 2016

(54) Ramp Assembly

(71) Applicants: Daniel Thornton, Salem, OR (US); Edward Martinez, Salem, OR (US)

(72) Inventors: Daniel Thornton, Salem, OR (US); Edward Martinez, Salem, OR (US)

(21) Appl. No.: 14/750,766

(22) Filed: Jun. 25, 2015

(51) Int. Cl. A61G 3/06; B65G 69/30; A61G 5/10

(52) U.S. Cl. CPC A61G 3/061; A61G 5/104; B65G 69/30

(57) ABSTRACT

A ramp assembly includes a platform that may be positioned adjacent to a door of a vehicle. The platform is positioned to be longitudinally coextensive with the vehicle thereby facilitating a disabled person to enter the vehicle. A plurality of legs is removably attached to the platform such that each of the legs may abut a support surface. A ramp is slidably coupled to the platform. The ramp is positionable in a deployed position having the ramp extending between the platform and the support surface. Thus, the ramp may facilitate a wheelchair to be rolled onto the platform thereby facilitating the disabled person to enter the vehicle. The ramp is positionable in a stored position having the ramp being stored within the platform.

### BACKGROUND OF THE DISCLOSURE

### Field of the Disclosure

The disclosure relates to ramp devices and more particularly pertains to a new ramp device for facilitating a disabled person to enter a vehicle.

### SUMMARY OF THE DISCLOSURE

An embodiment of the disclosure meets the needs presented above by generally comprising a platform that may be positioned adjacent to a door of a vehicle. The platform is positioned to be longitudinally coextensive with the vehicle thereby facilitating a disabled person to enter the vehicle. A plurality of legs is removably attached to the platform such that each of the legs may abut a support surface. A ramp is slidably coupled to the platform. The ramp is positionable in a deployed position having the ramp extending between the platform and the support surface. Thus, the ramp may facilitate a wheelchair to be rolled onto the platform thereby facilitating the disabled person to enter the vehicle. The ramp is positionable in a stored position having the ramp being stored within the platform.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a ramp assembly according to an embodiment of the disclosure.

FIG. 2 is a top view of an embodiment of the disclosure.

FIG. 3 is a right side view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

FIG. 6 is a front view of an embodiment of the disclosure in a folded and partially disassembled position.

### DESCRIPTION OF THE PREFERRED EMBODIMENT

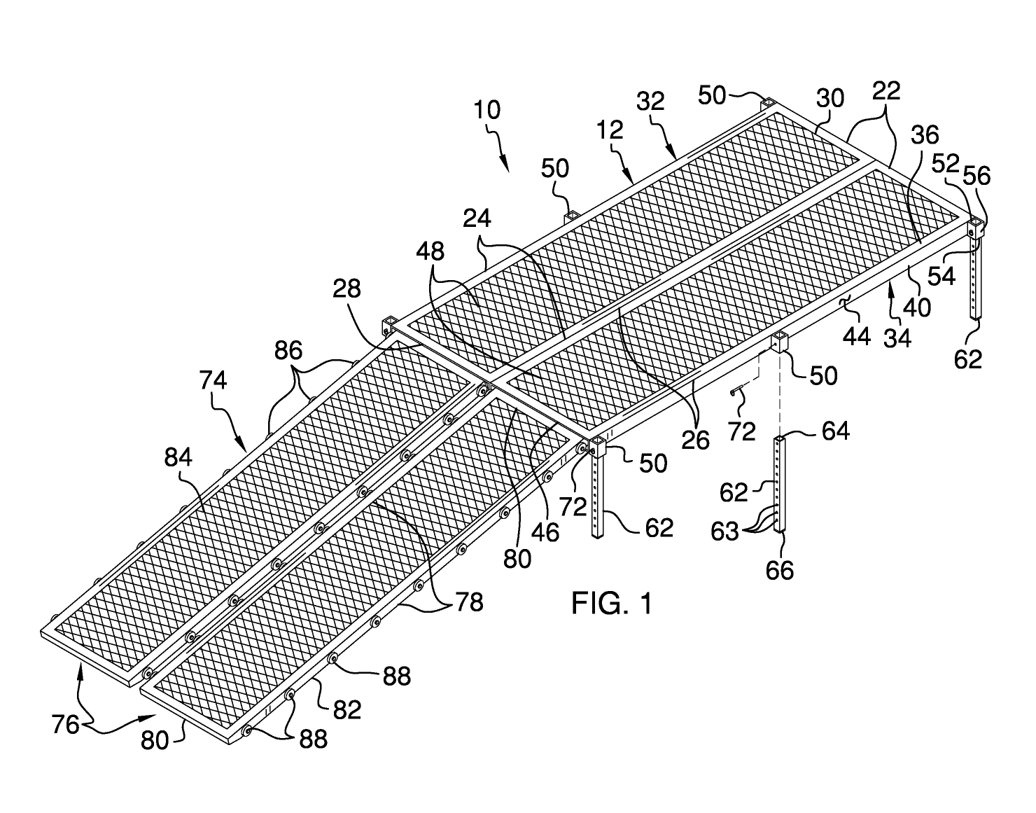

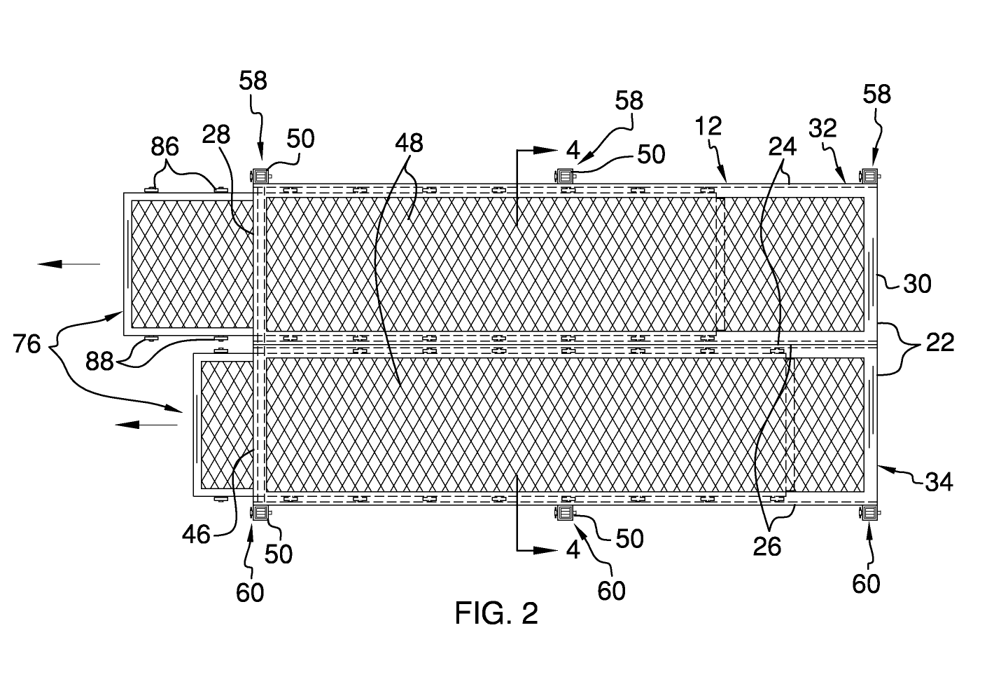

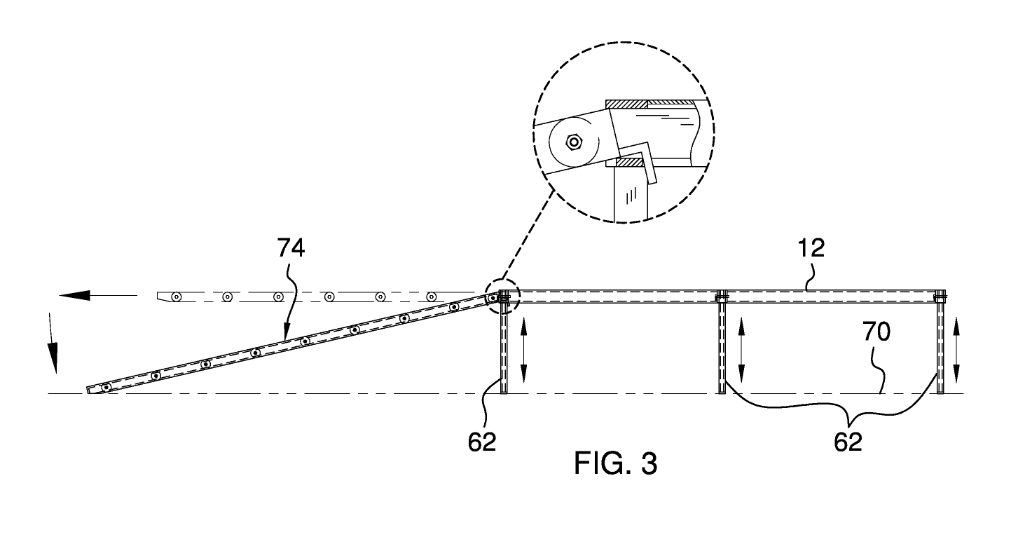

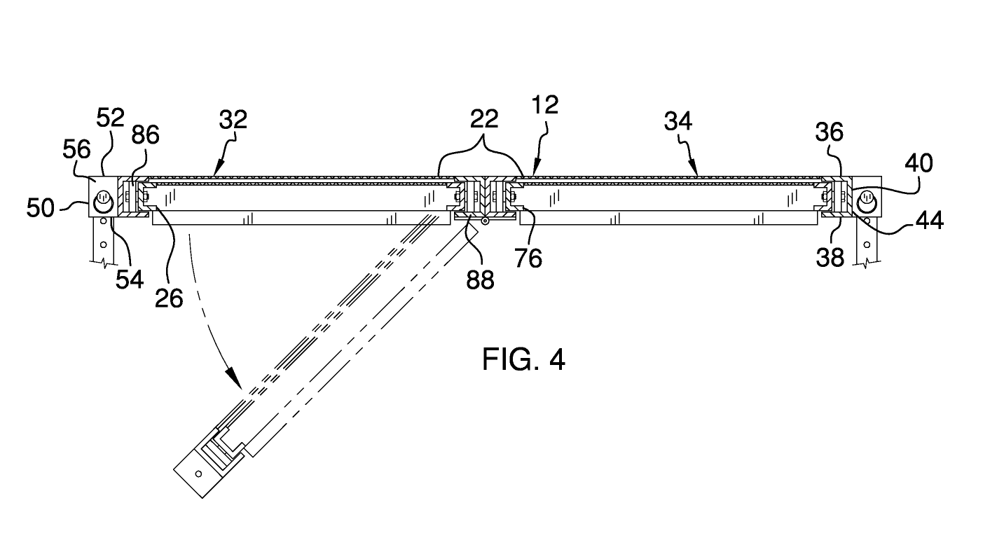

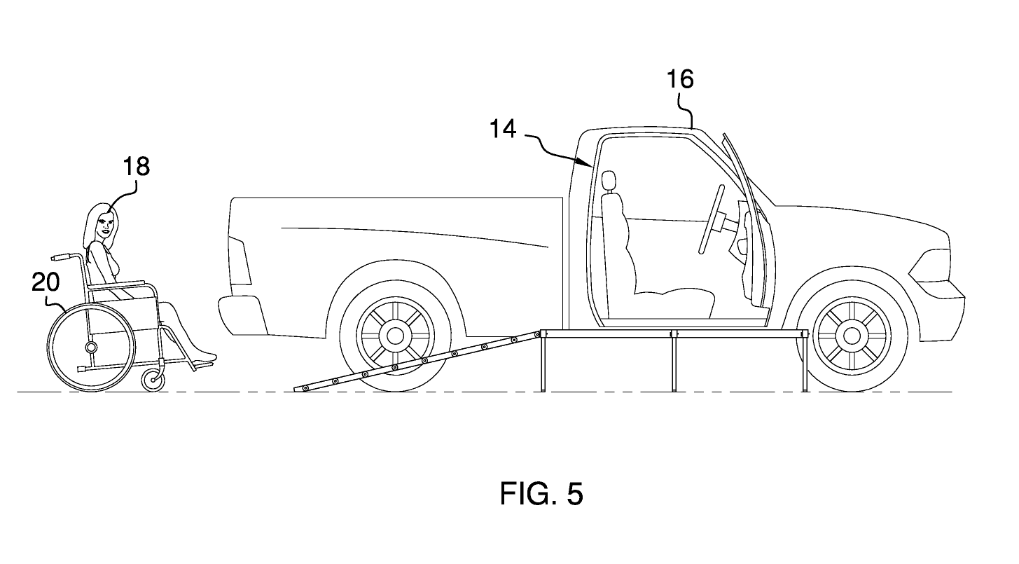

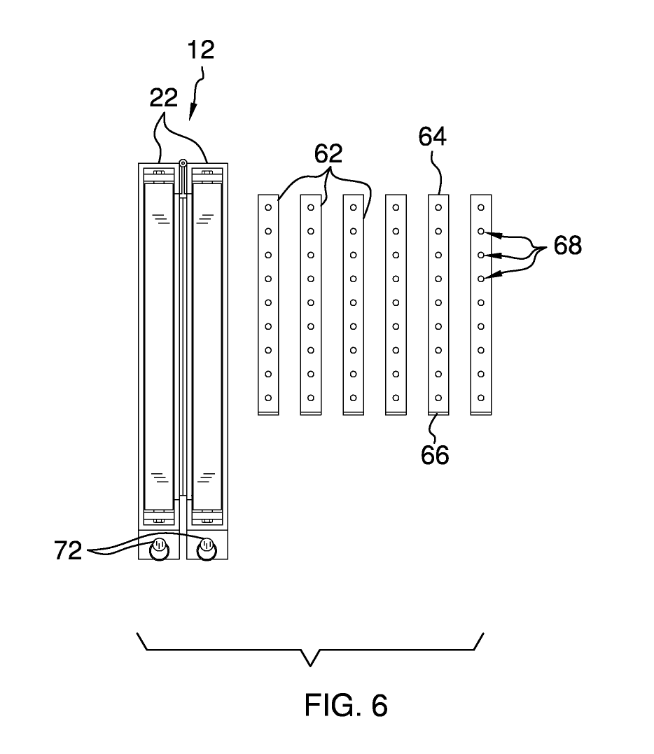

With reference now to the drawings, and in particular to FIGS. 1 through 6 thereof, a new ramp device embodying the principles and concepts of an embodiment of the disclosure and generally designated by the reference numeral 10 will be described.

As best illustrated in FIGS. 1 through 6, the ramp assembly 10 generally comprises a platform 12 that may be positioned adjacent to a door 14 of a vehicle 16. The platform 12 is positioned to be longitudinally coextensive with the vehicle 16 thereby facilitating a disabled person 18 to enter the vehicle 16. The vehicle 16 may be a pickup or the like and the disabled person 18 may utilize a wheelchair 20.

The platform 12 has a pair of sections 22 and each of the sections 22 comprises a first track 24, a second track 26, a first member 28 and a second member 30. Each of the first track 24 and the second track 26 is coupled to and extends between each of the first member 28 and the second member 30. The first track 24 and the second track 26 are spaced apart from each other such that each of the sections 22 has a rectangular shape. The pair of sections 22 includes a first one 32 of the sections 22 and a second one 34 of the sections 22. The second track 26 corresponding to the first section 32 is hingedly coupled to the first track 24 corresponding to the second section 34 such that the platform 12 is positionable between a folded position and an unfolded position.

Each of the first track 24 and the second track 26 has a top side 36 and a bottom side 38 that is each coupled to and extends away from a lateral side 40. The top side 36 and the bottom side 38 are spaced apart from each other to define a roller space 42 between the top side 36 and the bottom side 38. The lateral side 40 of each of the first track 24 and the second track 26 has an outwardly facing surface 44. The first member 28 has an outwardly facing side 46 and the outwardly facing side 46 is open.

A panel 48 is coupled between the first track 24, the second track 26, the first member 28 and the second member 30 such that the panel 48 may support the disabled person 18. The panel 48 may comprise a metallic mesh. A plurality of receivers 50 is provided and each of the receivers 50 has a top end 52, a bottom end 54 and a peripheral wall 56 extending between the top end 52 and the bottom end 54. The top end 52 and the bottom end 54 of each of the receivers 50 are open and the peripheral wall 56 of each of the receivers 50 is attached to the platform 12.

The plurality of receivers 50 comprises a first set 58 of the receivers 50 and a second set 60 of the receivers 50. The first set of receivers 58 is spaced apart from each other and distributed along the outwardly facing surface 44 of the first track 24 corresponding to the first section 32. The second set of receivers 60 is spaced apart from each other and distributed along the outwardly facing surface 44 of the second track 26 corresponding to the second section 34.

A plurality of legs 62 is provided and each of the legs 62 has an upper end 64 and a lower end 66. Each of the legs 62 has a plurality of apertures 68 extending therethrough and the apertures 68 are spaced apart from each other and are distributed between the upper end 64 and the lower end 66. Each of the legs 62 is insertable through an associated one of the receivers 50 such that the lower end 66 of each of the legs 62 may abut a support surface 70. The support surface 70 may be ground.

A plurality of pins 72 is provided and each of the pins 72 is extended through an associated one of the receivers 50 to engage a selected one of the apertures 68 in an associated one of the legs 62. Thus, each of the legs 62 retains the platform 12 at a selected height from the support surface 70 thereby facilitating the disabled person 18 to enter the door 14 of the vehicle 16.

A ramp 74 is slidably coupled to the platform 12. The ramp 74 is positionable in a deployed position having the ramp 74 extending between the platform 12 and the support surface 70. Thus, the ramp 74 facilitates a wheelchair 20 to be rolled onto the platform 12 thereby facilitating the disabled person 18 to enter the vehicle 16. The ramp 74 is positionable in a stored position having the ramp 74 being stored within the platform 12.

The ramp 74 is provided and the ramp has a pair of sections 76. Each of the sections 76 of the ramp 74 comprises a pair of primary members 78 that are each coupled to and extend between a pair of secondary members 80. The primary members 78 are spaced apart such that each of the sections 76 of the ramp 74 has a rectangular shape and each of the primary members 78 has an outwardly facing side 82. A panel 84 is coupled between each of the primary members 78 and each of the secondary members 80 such that the panel 84 may support the wheelchair 20. The panel 84 may comprise a metallic mesh.

Each of the sections 76 of the ramp 74 includes a first set of rollers 86 and each of the first set of rollers 86 is rotatably coupled to one of the primary members 78. Each of the sections 76 of the ramp 74 additionally includes a second set of rollers 88 and each of the second set of rollers 88 is rotatably coupled to one of the primary members 78. Each of the first set of rollers 86 rolls in the roller space 42 corresponding to the first track 24 and each of the second set of rollers 88 rolls in the roller space 42 corresponding to the second track 26. Thus, each of the sections 76 of the ramp 74 may be positioned between the deployed position and the stored position. The ramp 74 extends outwardly from the outwardly facing side 46 of an associated one of the sections 22 of the platform 12 when the ramp 74 is positioned in the deployed position.

In use, the platform 12 is positioned in the unfolded position and each of the legs 62 are inserted into an associated one of the receivers 50. The pins 72 are extended through the legs 62 and receivers 50 such that the platform 12 is retained at a height that facilitates the disabled person 18 to enter the door 14 of the vehicle 16. The ramp 74 is positioned in the deployed position and the wheelchair 20 is rolled up the ramp 74 to access the platform 12. The disabled person 18 enters the vehicle 14. The ramp 74 is positioned in the stored position, each of the legs 62 is removed from the receivers 50 and the platform 12 is positioned in the folded position thereby facilitating the platform 12 and the ramp 74 to be stored.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A ramp assembly configured to facilitate a disabled person to enter a vehicle, said assembly comprising:
a platform being configured to be positioned adjacent to a door of a vehicle such that said platform is longitudinally coextensive with the vehicle thereby facilitating a disabled person to enter the vehicle;
a plurality of legs being removably attached to said platform, wherein each of said legs is configured to abut a support surface;
a ramp being slidably coupled to said platform, said ramp being positionable in a deployed position having said ramp extending between said platform and the support surface wherein said ramp is configured to facilitate a wheelchair to be rolled onto said platform thereby facilitating the disabled person to enter the vehicle, said ramp being positionable in a stored position having said ramp being stored within said platform;
a plurality of receivers; and
each of said legs having an upper end and a lower end, each of said legs having a plurality of apertures extending therethrough, said apertures being spaced apart from each other and being distributed between said upper end and said lower end, each of said legs being insertable through an associated one of said receivers.

2. The assembly according to claim 1, wherein said platform has a pair of sections, each of said sections comprises a first track, a second track, a first member and a second member, each of said first track and said second track being coupled to and extending between each of said first member and said second member, said first track and said second track being spaced apart from each other such that each of said sections has a rectangular shape, said first member having a outwardly facing side, said outwardly facing side being open.

3. The assembly according to claim 2, wherein said pair of sections includes a first one of said sections and a second one of said sections, said second track corresponding to said first section being hingedly coupled to said first track corresponding to said second section wherein said platform is positionable between a folded position and an unfolded position.

4. The assembly according to claim 2, wherein each of said first track and said second track has a top side and a bottom side each being coupled to and extending away from a lateral side, said top side and said bottom side being spaced apart from each other to define a roller space between said top side and said bottom side, said lateral side of each of said first track and said second track having an outwardly facing surface.

5. The assembly according to claim 2, further comprising a panel being coupled between said first track, said second track, said first member and said second member wherein said panel is configured to support the disabled person.

6. The assembly according to claim 1, further comprising each of said receivers having a top end, a bottom end and a peripheral wall extending between said top end and said bottom end, said top end and said bottom end of each of said receivers being open, said peripheral wall of each of said receivers being attached to said platform.

7. The assembly according to claim 6, wherein:
said platform includes a first section and a second section, each of said sections having a first track and a second track, each of said first track and said second track having an outwardly facing surface; and
said plurality of receivers comprises a first set of said receivers and a second set of said receivers, said first set of receivers being spaced apart from each other and distributed along said outwardly facing surface of said first track corresponding to said first section, said second set of receivers being spaced apart from each other and distributed along said outwardly facing surface of said second track corresponding to said second section.

8. (canceled)

9. The assembly according to claim 1, further comprising a plurality of pins, each of said pins being extended through an associated one of said receivers and engaging a selected one of said apertures in an associated one of said legs wherein each of said legs is configured to retain said platform at a selected height from the support surface thereby facilitating the disabled person to enter the door of the vehicle.

10. The assembly according to claim 1, wherein said ramp has a pair of sections, each of said sections of said ramp comprising a pair of primary members each being coupled to and extending between a pair of secondary members, said primary members being spaced apart such that each of said sections of said ramp has a rectangular shape, each of said primary members having an outwardly facing side.

11. The assembly according to claim 10, further comprising a panel being coupled between each of said primary member and each of said secondary member wherein said panel is configured to support the wheelchair.

12. The assembly according to claim 10, wherein each of said sections of said ramps includes:
a first set of rollers, each of said first set of rollers being rotatably coupled to one of said primary members; and
a second set of rollers, each of said second set of rollers being rotatably coupled to one of said primary members.

13. The assembly according to claim 12, wherein:
said platform includes a pair of sections, a first track, a second track, each of said first track and said second track having a roller space, each of said sections having an outwardly facing side; and
each of said first set of rollers rolling in said roller space corresponding to said first track, each of said second set of rollers rolling in said roller space corresponding to said second track thereby facilitating each of said sections of said ramp to be positioned between said deployed position and said stored position, said ramp extending outwardly from said outwardly facing side of an associated one of said sections of said platform when said ramp is positioned in said deployed position.

14. A ramp assembly configured to facilitate a disabled person to enter a vehicle, said assembly comprising:
a platform being configured to be positioned adjacent to a door of a vehicle such that said platform is longitudinally coextensive with the vehicle thereby facilitating a disabled person to enter the vehicle, said platform having a pair of sections, each of said sections comprising:
a first track, a second track, a first member and a second member, each of said first track and said second track being coupled to and extending between each of said first member and said second member, said first track and said second track being spaced apart from each other such that each of said sections has a rectangular shape, said pair of sections including a first one of said sections and a second one of said sections, said second track corresponding to said first section being hingedly coupled to said first track corresponding to said second section wherein said platform is positionable between a folded position and an unfolded position, each of said first track and said second track having a top side and a bottom side each being coupled to and extending away from a lateral side, said top side and said bottom side being spaced apart from each other to define a roller space between said top side and said bottom side, said lateral side of each of said first track and said second track having an outwardly facing surface, said first member having a outwardly facing side, said outwardly facing side being open, and
a panel being coupled between said first track, said second track, said first member and said second member wherein said panel is configured to support the disabled person;
a plurality of receivers, each of said receivers having a top end, a bottom end and a peripheral wall extending between said top end and said bottom end, said top end and said bottom end of each of said receivers being open, said peripheral wall of each of said receivers being attached to said platform, said plurality of receivers comprising a first set of said receivers and a second set of said receivers, said first set of receivers being spaced apart from each other and distributed along said outwardly facing surface of said first track corresponding to said first section, said second set of receivers being spaced apart from each other and distributed along said outwardly facing surface of said second track corresponding to said second section;
a plurality of legs, each of said legs having an upper end and a lower end, each of said legs having a plurality of apertures extending therethrough, said apertures being spaced apart from each other and being distributed between said upper end and said lower end, each of said legs being insertable through an associated one of said receivers wherein said lower end of each of said legs is configured to abut a support surface;
a plurality of pins, each of said pins being extended through an associated one of said receivers and engaging a selected one of said apertures in an associated one of said legs wherein each of said legs is configured to retain said platform at a selected height from the support surface thereby facilitating the disabled person to enter the door of the vehicle;
a ramp being slidably coupled to said platform, said ramp being positionable in a deployed position having said ramp extending between said platform and the support surface wherein said ramp is configured to facilitate a wheelchair to be rolled onto said platform thereby facilitating the disabled person to enter the vehicle, said ramp being positionable in a stored position having said ramp being stored within said platform, said ramp having a pair of sections, each of said sections of said ramp comprising:
a pair of primary members each being coupled to and extending between a pair of secondary members, said primary members being spaced apart such that each of said sections of said ramp has a rectangular shape, each of said primary members having an outwardly facing side,
a panel being coupled between each of said primary member and each of said secondary member wherein said panel is configured to support the wheelchair,
a first set of rollers, each of said first set of rollers being rotatably coupled to one of said primary members, and
a second set of rollers, each of said second set of rollers being rotatably coupled to one of said primary members, each of said first set of rollers rolling in said roller space corresponding to said first track, each of said second set of rollers rolling in said roller space corresponding to said second track thereby facilitating each of said sections of said ramp to be positioned between said deployed position and said stored position, said ramp extending outwardly from said outwardly facing side of an associated one of said sections of said platform when said ramp is positioned in said deployed position.
